(19) United States
(12) Patent Application Publication
(10) Pub. No.: US 2004/0015684 A1
(43) Pub. Date: Jan. 22, 2004

(54) Method, apparatus and computer program product for scheduling multiple threads for a processor

(75) Inventor: James Lyle Peterson, Austin, TX (US)

Correspondence Address: Casimer K. Salys, International Business Machines Corporation, Intellectual Property Law Dept., Internal Zip 4054, 11400 Burnet Road, Austin, TX, 78758, US

(73) Assignee: International Business Machines Corporation, Armonk, NY (US)

(21) Appl. No.: 10/159,480

(22) Filed: May 30, 2002

(51) Int. Cl. G06F 15/00; G06F 9/44; G06F 7/38; G06F 9/00

(52) U.S. Cl. 712/245

(57) ABSTRACT

In one form of the invention, a method for scheduling multiple instruction threads for a processor in an information handling system includes communicating, to processor circuitry by an operating system, a selected schedule of instruction threads for a set of instructions. The processor circuitry switches from executing one of the threads with one of the contexts to executing another of the threads with another of the contexts, responsive to the schedule received from the operating system.

### BACKGROUND

1. Field of the Invention

The present invention concerns scheduling multiple instruction threads by a processor in an information handling system, and more particularly concerns hardware and software that support more flexibility in the way threads are scheduled for a processor in an information handling system.

2. Related Art

As the technology of processor chips has improved, they have gotten smaller, faster and more complex. Improvement in processing techniques allows more circuitry on a given die size. One result has been sophisticated classes of machines such as super scalar designs. Of particular interest for the present invention is development of multi-threaded processors. To understand multi-threaded processors as related to the present invention, it is important to understand certain terminology concerning “processes” and “threads,” both from a software and hardware perspective, and to understand the hardware term “context.”

From a software point of view, the term “task” has become more widely referred to as a “process.” In the software context, these terms refer to an execution of a sequence of instructions, which typically requires a program counter pointing to an instruction and a set of registers pointing to or operating on data. Two or more processes can run “concurrently” on the same processor, in the sense that processor hardware can very quickly alternate among servicing the multiple processes so that from the viewpoint of a user it appears that the processes are running simultaneously. Two processes can operate on two different sets of data or on the same data, but even if they operate on the same data they generally have their own respective copies of the data in their own separate address spaces. This gives rise to a resource issue, since having two copies of an entire data space can consume a lot of memory. Also, if two processes are working on the same data and need to cooperate, their independence presents an obstacle. These issues gave rise to software threads, which may be thought of as light weight processes that share data. In certain circumstances threads are advantageous in terms of memory consumption and cooperation on a common set of data.

To understand hardware contexts, reference is made now to FIGS. 1 and 2. Referring first to FIG. 1, a conventional information handling system 100 is shown, with processor circuitry 120, including a number of functional units 125 and a set of registers 130 for use by the functional units 125 in performing computations. The register set 130 includes a program counter 134, a stack pointer 136 and a set of general purpose registers 132. The processor circuitry 120 performs computations responsive to a set of instructions 110. Some subsets 112 of the instructions 110 are designated to be executed as respective threads, and accordingly instructions in a particular subset 112 are tagged with a corresponding thread identifier 114. (It should bc understood that a subset 112 can include the entire set of instructions 110, in which case the entire set of instructions 110 is designated as a single thread.)

FIG. 1 illustrates conventional switching between two threads, as follows. Operands are loaded 150 into the registers 130 and processed 152 by one or more of the functional units 125 responsive to a first one of the subsets 112 of instructions 110, according to a first thread. Then, to switch to a second thread, results are saved 154 from the registers 130 to a memory 140, and new operands are loaded 156 into the registers 130 and processed 158 by one or more of the functional units 125 responsive to a second one of the sets 112 of instructions 110.

Referring now to FIG. 2, another conventional information handling system 200 is illustrated that takes advantage of the previously mentioned improvements in space available on a chip. That is, the additional space permits inclusion of multiple sets of registers 230, instead of just the single set 130 of FIG. 1. Operands for a first one of the subsets 212 of instructions 210 are loaded 250 into one of the sets of registers 230, which is dedicated to execution of the first one of the threads, and processed 252 by one or more of the functional units 225 responsive to the first one of the subsets 212 of instructions 110. To switch to the second one of the threads, new operands for the second one of the subsets 212 of instructions 110 are merely loaded 254 into the second set of registers 230 and processed 256 by one or more of the functional units 225 responsive to the second one of the instruction threads 212. That is, results do not have to be saved from the registers 230 to a memory, since the register sets 230 are dedicated to respective threads 212.

According to the arrangement of FIG. 2, each set of registers 230 is called a “context.” Several processors have been designed with multiple contexts. For example, IBM has designed a PowerPC processor, the RS64IV processor, with 2 contexts. Intel has likewise designed a processor, the Xeon processor, with 2 contexts. The Compaq Alpha 21464 has 4 contexts, while the CRAY MTA provides 128 contexts.

From a hardware point of view, a “thread” can be either a “process” or a “thread” in software terms, depending on whether virtual memory registers are included as part of the context. Herein, a thread or process being executed using a particular hardware context may be referred to interchangeably as a thread or a context. For the above mentioned processor designs, a thread identifier (which also may be referred to as a “context identifier”) ranging from one to seven bits is sufficient to identify a context, depending on the number of contexts of the particular design. For an out of order, super scalar processor, register values flowing through the processor pipeline are tagged with their respective contexts, thereby allowing computations from multiple contexts to be in progress at the same time, while permitting the results to be put back in the correct contexts when they're finished.

With multiple contexts available on a processor, it is likely that several of the contexts may be enabled and ready to execute at the same time, so that the processor must schedule the multiple contexts. This scheduling has conventionally been done in several different ways. Course-grained multi-threading executes instructions from one context until the context becomes blocked for some long latency event such as a cache miss, whereupon the processor switches to another context. Fine-grained multi-threading executes one instruction at a time from each context. That is, the context is switched after each instruction. In simultaneous multi-threading, performed by super scalar, out-of-order processors, the context is switched without necessarily waiting for an instruction of a previous context to be completed.

Due to the size and speed improvements previously mentioned, the trend is toward providing more than two contexts on a processor. Systems that support more than two contexts must deal not only with when to switch among contexts but also selecting among them. Studies of the most efficient way to schedule a multi-threaded processor have considered such events as processor functional unit utilization and long-latency accesses to main memory or non-local caches, which may cause the processor to stall while waiting for data. A need exists for more scheduling techniques that are especially suitable for larger numbers of contexts. Also, thread scheduling is conventionally built into the hardware design in such a manner that it may be difficult to accommodate new developments in thread scheduling. Consequently, a need also exists for new scheduling techniques and for hardware and software that support more flexibility in changing the way contexts and threads are scheduled.

### SUMMARY OF THE INVENTION

The foregoing need is addressed in the present invention. In one form of the invention, a method for scheduling multiple threads in an information handling system includes an operating system communicating to processor circuitry a selected schedule for executing threads with respective contexts of the processor circuitry. The processor circuitry switches from executing one of the thread with one of the contexts to executing another of the threads with another of the contexts, responsive to the schedule received from the operating system.

It should be appreciated that while it was previously known for an operating system to assign instructions to threads and even to direct the threads to respective contexts; nevertheless, in the prior art once the software directed the threads to the contexts, the processor circuitry took over scheduling of the contexts.

In a further aspect of the present invention, each thread has a corresponding thread identifier, and the communicating to the processor circuitry includes communicating a schedule of selected thread identifiers. The processor circuitry loads the selected thread identifiers as respective entries in a thread scheduling register.

In yet another aspect, the switching from executing one thread to another includes reading an index which points to one of the entries of the thread scheduling register. Then the thread identifier is read from the entry indicated by the index, and at least one instruction is executed for the thread corresponding to the identifier. The index is incrementing to point to a next entry in the thread scheduling register, and the next thread identifier in the next entry is read. Then at least one instruction is executed for the thread corresponding to that next identifier, and so on.

In a still further aspect, a selected length for the thread scheduling register is communicated to the processor circuitry.

In an additional aspect, one of the threads in the selected schedule is a special thread that modifies the selected thread schedule.

Objects, advantages, additional aspects and other forms of the invention will become apparent upon reading the following detailed description and upon reference to the accompanying drawings.

### BRIEF DESCRIPTION OF THE DRAWINGS

FIG. 1 illustrates aspects of thread switching in an information handling system having a processor with a single register set, according to prior art.

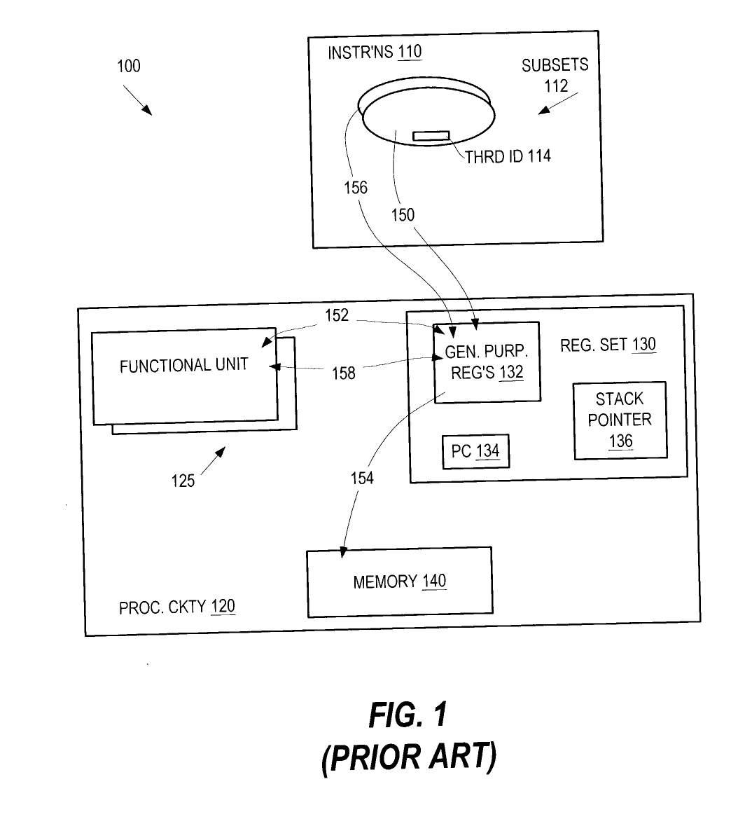

FIG. 2 illustrates aspects of thread switching in an information handling system having a processor with multiple register sets for handling multiple threads, according to prior art.

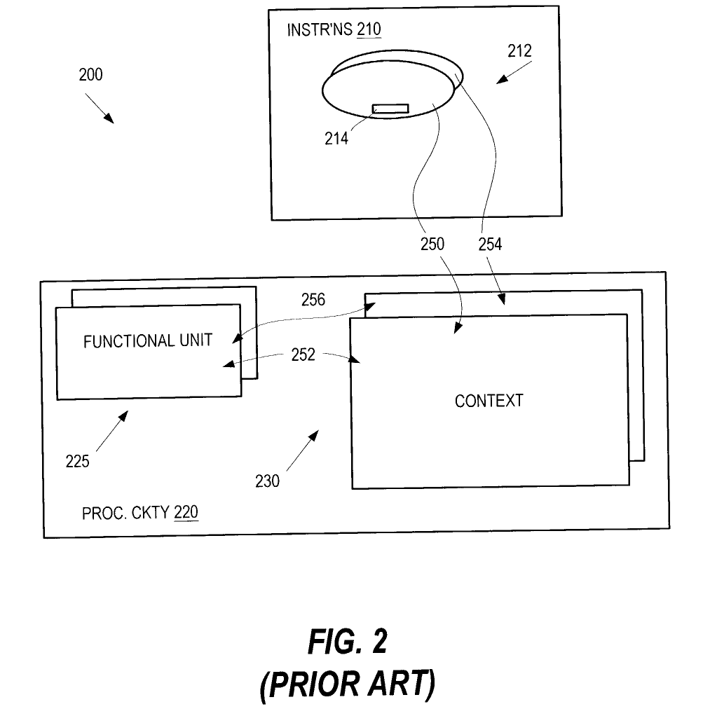

FIG. 3 illustrates aspects of a more flexible thread switching arrangement for an information handling system, according to an embodiment of the present invention.

FIGS. 4A through 4C illustrate aspects of a thread scheduling register and entry of thread identifiers in the register, according to an embodiment of the present invention.

FIGS. 5A through 5D illustrate a mechanism for sequentially reading the entries of the thread scheduling register, according to an embodiment of the present invention.

FIG. 6 illustrates aspects of logic function, according to an embodiment of the present invention.

FIG. 7 illustrates additional aspects of an information handling system, according to an embodiment of the present invention.

### DETAILED DESCRIPTION OF A PREFERRED EMBODIMENT

The claims at the end of this application set out novel features which applicants believe re characteristic of the invention. The invention, a preferred mode of use, further objectives and advantages, will best be understood by reference to the following detailed description of an illustrative embodiment read in conjunction with the accompanying drawings.

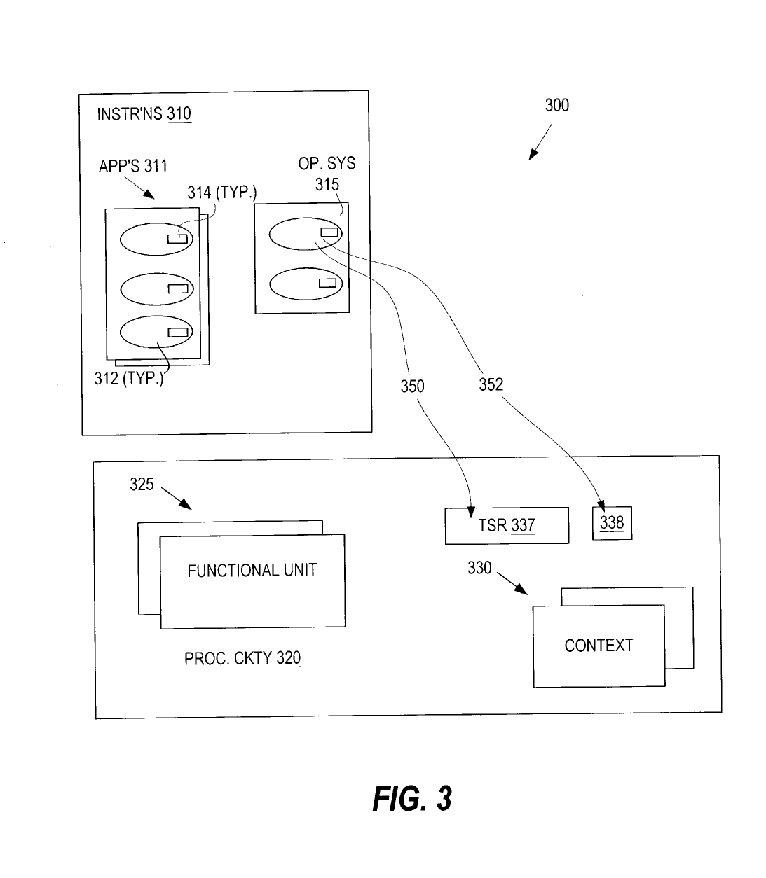

Referring now to FIG. 3, an information handling system 300 is illustrated, according to an embodiment of the present invention. The system 300 has a set of instructions 310 stored in a memory (not shown), which include instructions 310 for a number of applications 311 and an operating system 315, among other things. In the embodiment shown, one of the applications 311 has sets of instructions 312 designated for three threads and the operating system 315 has sets of instructions 312 designated for two threads specifically depicted. Each of the sets 312 has its own thread identifier 314.

The information handling system 300 also has processor circuitry 320, which includes functional units 325, such as arithmetic logic units, load/store units, etc., register sets 330 (also referred to as “contexts”), a thread scheduling register (“TSR”) 337 and a TSR length register 338.

One of the sets 312 of instructions 310 of the operating system 315 is a “scheduling” thread for selecting among threads and ordering their execution and also for communicating 350 the schedule to the TSR 337 of the processor circuitry 320. That is, sets 312 of instructions 310, are assigned to respective threads and are assigned thread identifiers 314. The scheduling thread selectively assigns the instruction sets 312 to respective contexts 330 for thread execution and schedules an operating sequence for the contexts 330 by assigning thread identifiers 314 to entries of the TSR 337. (Since assigning a thread to a context and scheduling the context has the effect of scheduling the thread, reference herein is made interchangeably to “scheduling contexts” and “scheduling threads.”)

While it is known in the prior art for the operating system 315 to schedule certain resources of the system 300, including managing memory and I/O devices (not shown in FIG. 3), assigning instructions 310 to threads 312 and mapping the threads 312 to contexts 330, in current architectures the operating system has no control over how scheduling is done among the contexts once threads are assigned to contexts 330. The present embodiment advantageously provides the operating system 315 the new function of the thread/context scheduling process. The instructions of the scheduling process of the operating system 315 are processed by processor circuitry 320 “concurrently” with others of the instructions 310 in the sense that the scheduling process is executed at runtime along with applications 311.

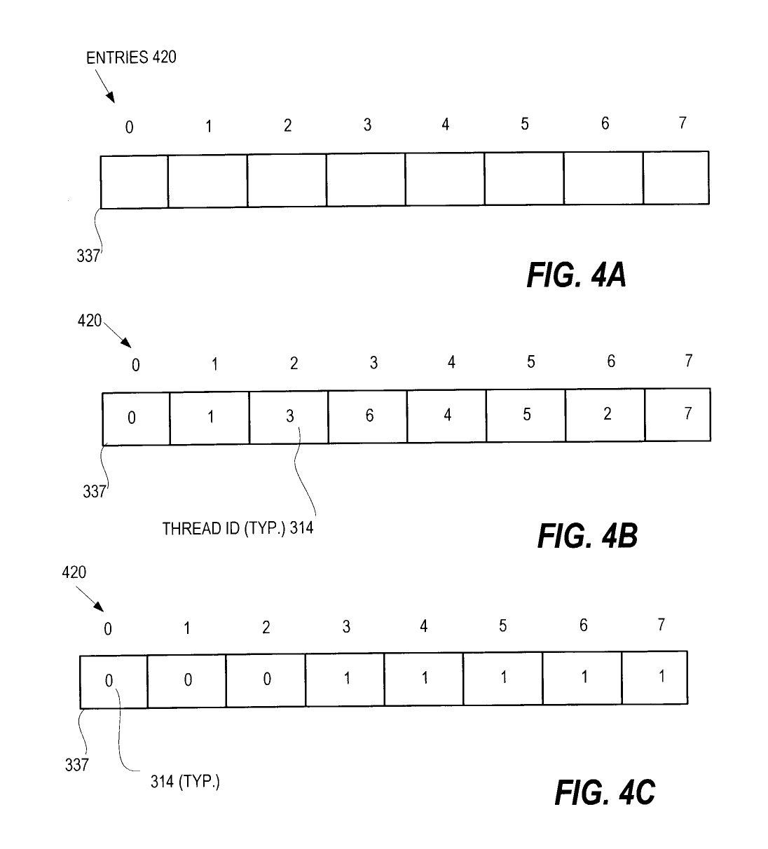

Referring now to FIGS. 4A through 4C, aspects are illustrated of the thread scheduling register 337 and entry of thread identifiers 314 in the register 337, according to an embodiment of the present invention. In FIG. 4A the thread scheduling register 337 is shown that has storage space for eight register entries 420, which are shown numbered 0 through 7. In the embodiment illustrated, the entries 420 are each 4 bits and the register 337 is 32 bits. Of course, in other embodiments to register 337 has a different number of entries 420 or each entry is of a different size. The processor circuitry 320 (FIG. 3) reads the contents of the entries 420 in sequence and sequentially executes instructions 312 (FIG. 3) for the respective threads indicated by the entries 420.

In FIG. 4B the thread scheduling register 337 is shown with entries 420 loaded with eight different thread identifiers 314, so that the processor circuitry 320 (FIG. 3) allocates its execution among the eight different corresponding threads in substantially equal proportion. In particular, thread 0 is in entry 420 number 0, thread 1 is in entry 420 number 1, thread 3 is in entry 420 number 2, thread 6 is in entry 420 number 3, and so on. (It should be understood that the execution time spent on each of the threads may not be literally precisely equal, since different instructions have different latency.)

In FIG. 4C, the thread scheduling register 337 is shown loaded with multiple instances of only two thread identifiers 314, so that the processor circuitry 320 (FIG. 3) allocates its execution among only the two corresponding threads. In particular, thread number 0 is in entry 420 numbers 0 through 2 and thread number 1 is in entry 420 numbers 3 through 7, SO that processor circuitry 320 allocates ⅜ of its execution time to thread number 0 and ⅝ of its execution time to thread 312 number 1.

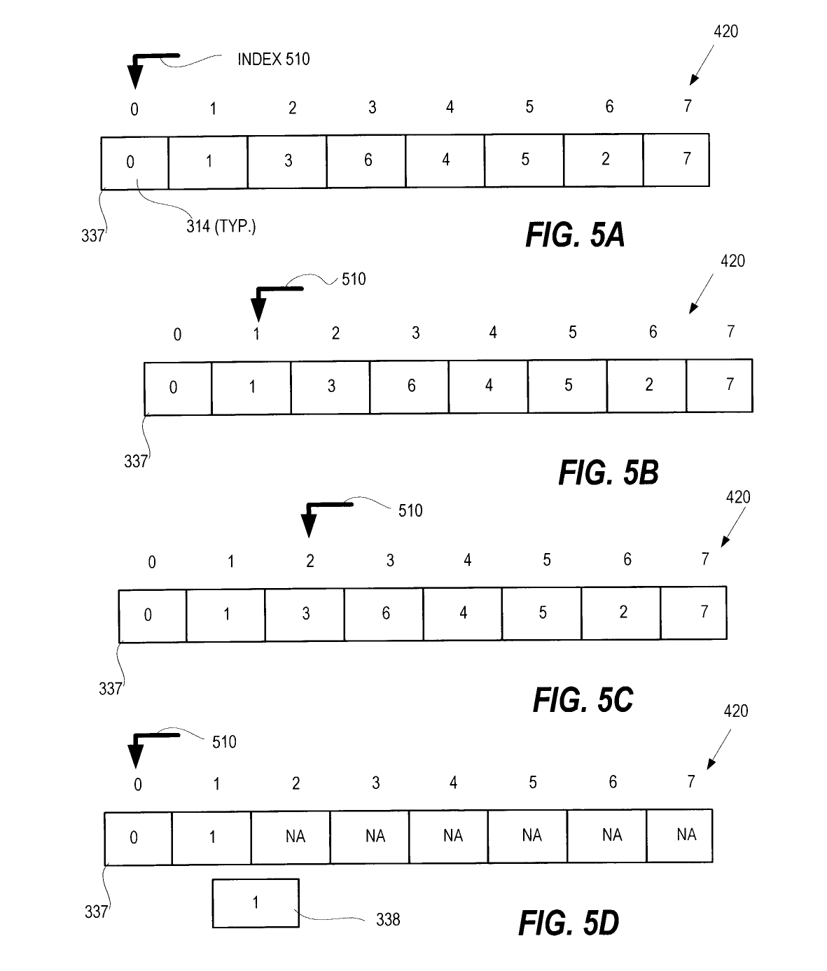

Referring now to FIGS. 5A through 5D a mechanism is illustrated for sequencing the entries 420 of the thread scheduling register 337, according to an embodiment of the present invention. In FIG. 5A the register 337 is shown loaded with eight different thread identifier 314, as in FIG. 4B. Also shown is an index 510 pointing at entry 420 number 0. After the first entry 420 number 0 is read, that is, thread identifier 314 number 0 in the illustrated instance, and one instruction of the corresponding thread 312 (FIG. 3) is executed by processor circuitry 320 (FIG. 3), the index 510 is incrementing by 1, so that in FIG. 5B the index 510 points to the next entry 420 number 1. One instruction of thread 1 is executed. Next, the index 510 is again incremented by 1, so that in FIG. 5C the index 510 points to the next entry 420 number 2. This continues until the index reaches the end of the register 337, that is, entry 420 number 7, at which point the index 510 is reset to 0.

Referring now to FIG. 5D, a mechanism is illustrated for specifying a different length for the thread scheduling register 337. In the illustrated instance, TSR length register 338 is shown with value of the contents equal one, indicating that the index 510 for the thread scheduling register 337 should be reset to 0 after entry 420 number 1 is read. This has the effect of reducing the length of the eight-entry capacity thread scheduling register 337 to two entries 420.

Note also, that this mechanism of FIG. 5D can be an alternative to the scheduling arrangement of FIG. 4C. That is, in FIG. 4C thread number 0 was loaded in the first three entries 420 of the register 337 and thread number 1 was loaded in the last five entries 420, for a ⅜-⅝ processor 320 execution allocation between the two threads. If a 4/8-4/8 allocation had been desired instead, the thread number 0 could have been loaded in the first four entries 420 and thread number 1 could have been loaded in the last four entries 420. The mechanism of FIG. 5D provides an alternative for achieving equal allocation between the two threads numbers 0 and 1, although in the illustrated instance of the mechanism FIG. 5D there will be fewer instructions executed between thread switches than in the case of the 4/8-4/8 allocation using all eight entries 420.

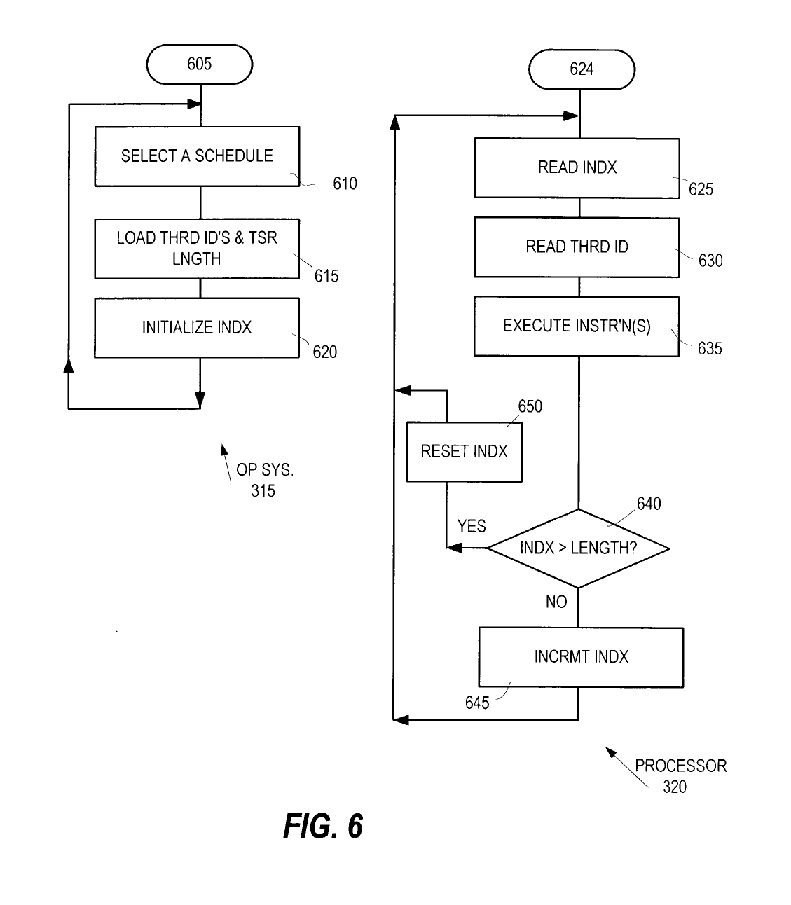

Referring now to FIG. 6 aspects are illustrated of logic function, according to an embodiment of the present invention. Logic for context scheduling by the operating system 315 is set out beginning at 605. At 610 the operating system 315 selects and orders threads for execution. In connection with this step, the operating system 315 also selects a length for the thread scheduling register. Next, at 615, thread identifiers for the threads that were selected and ordered in step 610 are communicated to and loaded in respective entries of the thread scheduling register by the operating system 315. Also at 615 loads the selected length for the thread scheduling register in the TSR length register. Then, at 620, the operating system 315 initializes the thread scheduling register index to point at the first entry of the register. As shown in the illustrated embodiment, these steps 610-620 are performed repeatedly. This repetition will be described further herein below with regard to dynamic, continuous scheduling.

Logical functioning of the processor 320 is set out beginning at 624. Next, at 625 the processor 320 reads the index initialized in step 620 by the operating system 315. At 630 the processor circuitry 320 reads the entry of the TSR that is pointed to by the index. This entry contains the thread identifier that the operating system 315 loaded in the entry in step 615. Next, at 635, the processor executes at least one instruction of the indicated thread in the thread's assigned context.

Next the processor 320 logic goes to block 640, at which the current value of the index is compared to the current value of the TSR length register. If the index is pointing to the last entry of the TSR, i.e., the value indicated by the length register, then the index is reset at 650 to point to the first entry of the TSR. Otherwise, the index is incremented at 645, and the processor 320 returns to step 625.

Certain logical functions not explicitly shown in FIG. 6 are as follows. When the processor is reset, such as at initial power on, all the entries of the thread scheduling register are set to 0, so that instructions from context 0 are initially executed. The thread scheduling register is a protected register and can only be loaded by the operating system. Prior to putting a thread identifier into the thread scheduling register, the operating system initializes all the registers in that context, including the program counter and stack pointer.

If the thread associated with a selected context is unable to issue an instruction, such as due to being stalled for a long latency event like a fetch from memory, the processor proceeds to the thread and context indicated in the next thread scheduling register entry.

If an event such as a trap, system call or interrupt is detected, one or more of the selected thread identifiers are reset to a special thread of the operating system for handling the event. In an alternative embodiment, contents of the context register set of the currently executing thread is modified to reflect the event, and the values in the thread scheduling register are not modified.

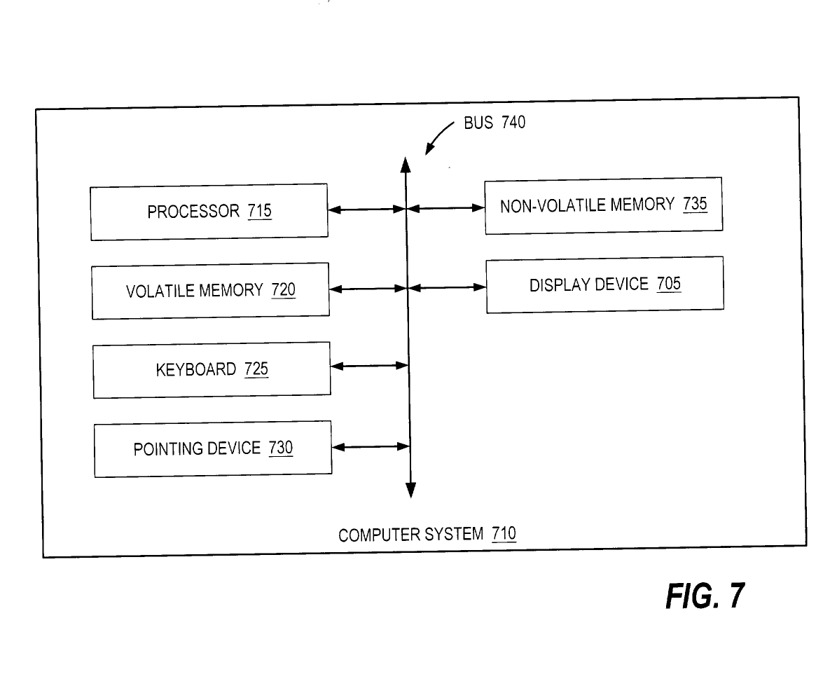

Referring now to FIG. 7 additional aspects are illustrated of an information handling system, according to an embodiment of the present invention. The system 710 includes a processor 715, a volatile memory 720, e.g., RAM, a keyboard 725, a pointing device 730, e.g., a mouse, a nonvolatile memory 735, e.g., ROM, hard disk, floppy disk, CD-ROM, and DVD, and a display device 705 having a display screen. Memory 720 and 735 are for storing program instructions which are executable by processor 715 to implement various embodiments of a method in accordance with the present invention. Components included in system 710 are interconnected by bus 740. A communications device (not shown) may also be connected to bus 740 to enable information exchange between system 710 and other devices.

The description of the present embodiment has been presented for purposes of illustration, but is not intended to be exhaustive or to limit the invention to the form disclosed. Many modifications and variations will be apparent to those of ordinary skill in the art. For example, while certain aspects of the present invention have been described in the context of particular circuitry, those of ordinary skill in the art will appreciate that processes of the present invention are capable of being performed by a processor responsive to stored instructions, and accordingly some or all of the processes may be distributed in the form of a computer readable medium of instructions in a variety of forms and that the present invention applies equally regardless of the particular type of signal bearing media actually used to carry out the distribution. Examples of computer readable media include RAM, flash memory, recordable-type media, such a floppy disk, a hard disk drive, a ROM, and CD-ROM, and transmission-type media such as digital and analog communications links, e.g., the Internet.

It should be appreciated that the above described embodiment provides a number of advantages. The relatively straightforward arrangement allows hardware to quickly switch on an instruction-by-instruction basis among multiple threads. The operating system can define a set of policies which can be mapped onto the hardware mechanism, allowing the operating system to decide how the hardware, including the processor, is to be scheduled.

Switching the processor among threads after each instruction effectively shares the processor hardware among multiple threads. Although the hardware defines the maximum length of the thread scheduling register, the effective length is adjustable as described above. The effective number of entries in the TSR defines a resolution of the sharing of the processor. That is, if there are eight entries in the TSR, the processor can be shared down to a resolution of one eighth of the total processor, while if there are 128 entries, the processor can be shared in units of 1/128.

It should be understood from the above, however, that even with the relatively higher resolution of a 128 entry TSR, this does not mean that 128 different threads must each run at 1/128th the speed of the processor. Processing time is allocated to any one particular thread in proportion to the number of entries for that thread's identifier in the thread scheduling register.

The arrangement described herein above is flexible enough to allow implementing many different scheduling algorithms among the threads which the operating system maps on to the processor contexts, such as the following:

Simple processor sharing. For this scheduling the thread identifiers for n threads are loaded into the TSR entries in as nearly equal proportions as possible. For example, processor sharing among three threads could be approximated for a TSR of 128 entries by entering the thread identifier for one of the threads in 42 of the TSR entries and each of the thread identifiers for the other two threads in 43 of the TSR entries apiece.

Weighted processor sharing. For this scheduling a weight is defined for each of the n threads. For example, 3 threads could be given weights ½, ⅓ and ⅙ and expressed in terms of the least common denominator, as 3/6, 2/6 and ⅙then the thread scheduling register can be set to the length of the least common denominator, that is, 6, and the thread identifiers can be loaded in 3, 2 and 1 entries of the register, respectively. (If the length cannot be set equal to the least common denominator, an approximation can be made.) Note that this is a good alternative to strict priority scheduling, since priority scheduling can suffer from “starvation” of lower priority threads. Instead of a strict priority scheduling the weighted processor sharing can be applied in a fashion according to which a thread with twice the priority it receives twice the weight, and thus twice the processing.

Round robin. For this scheduling, provided that the thread scheduling register is a multiple of n, one instance of each thread identifier is loaded for each of n threads, and then the pattern is repeated.

First-come-first-served. Setting the effective length of the thread scheduling register to 1, or filling the TSR with only thread identifier results in execution being dedicated to the one thread, allowing the operating system to implement a first-come-first-served scheduling algorithm.

Dynamic, continuous scheduling. In one embodiment, n threads are scheduled in a thread scheduling register of effective length n+1, and the extra entry points to a dynamic scheduling thread in the operating system kernel which therefore executes 1 out of every n+1 instructions (or sets of instructions if more than one instruction is executed for each entry in the TSR). The dynamic scheduling thread dynamically modifies the contents of the thread scheduling register. That is, for example, the dynamic scheduling thread reselects the schedule and causes the TSR to be reloaded with each pass through the TSR. Alternatively, the dynamic scheduling thread may be executed numerous times before it reselects the schedule and reload its TSR, so that the TSR is not reloaded on every single round. In either case, the dynamic scheduling thread can morc or less continuously monitor execution and change the thread schedule concurrently with execution of the threads. By keeping at least one entry of the TSR always allocated to a dynamic scheduling thread, the operating system may continuously monitor and reschedule the processor without the need for a timer or timer interrupt. In one embodiment, by having the dynamic scheduling thread poll the various I/O devices, the system is designed with no interrupt circuitry, allowing a smaller and simpler system.

To reiterate, many additional aspects, modifications and variations are also contemplated and are intended to be encompassed within the scope of the following claims. Moreover, it should be understood that in the following claims actions are not necessarily performed in the particular sequence in which they are set out.

What is claimed is:

1. A method in an information handling system for scheduling multiple instruction threads for a processor, the method comprising the steps of:
a) communicating, to processor circuitry by an operating system, a selected schedule of instruction threads for a set of instructions; and
b) switching, by the processor circuitry, from executing one of the threads with one of the contexts to executing another of the threads with another of the contexts, responsive to the schedule received from the operating system.

2. The method of claim 1, wherein each thread has a corresponding thread identifier, and step a) comprises loading a schedule of selected thread identifiers as respective entries in a thread scheduling register.

3. The method of claim 2, wherein step b) comprises:
b1) reading an index, wherein the index points to one of the entries of the thread scheduling register;
b2) reading the thread identifier in the entry indicated by the index read in step b1);
b3) executing at least one instruction for the thread corresponding to the identifier read in step b2);
b4) incrementing the index to point to a next entry in the thread scheduling register;
b5) reading the thread identifier in the entry indicated by the index read in step b4); and
b6) executing at least one instruction for the thread corresponding to the identifier read in step b5).

4. The method of claim 2, comprising communicating to the processor circuitry a selected length for the thread scheduling register.

5. The method of claim 2, wherein at least one of the threads in the schedule comprises a dynamic scheduling thread and executing the dynamic scheduling thread modifies an entry in the thread scheduling register, so that the thread schedule is modified dynamically.

6. The method of claim 5, comprising the step of polling I/O devices responsive solely to the dynamic scheduling thread rather than responsive to a timer.

7. The method of claim 1, wherein the switching is further responsive to encountering a stall for a thread.

8. The method of claim 1, wherein the processor circuitry switches to executing a special thread responsive to at least one of the following events: a system call, an interrupt, and a trap condition.

9. The method of claim 3, wherein for each fetching of the at least one instruction only a single instruction is fetched.

10. The method of claim 3, wherein for each fetching of the at least one instruction numerous instructions are fetched.

11. An information handling system having a processor and means for scheduling multiple instruction threads for the processor, the information handling system comprising:
an operating system; and
processor circuitry, wherein the operating system is operable to communicate to the processor circuitry a selected schedule of instruction threads for a set of instructions, and the processor circuitry is operable to switch from executing one of the threads with one of the contexts to executing another of the threads with another of the contexts, responsive to the schedule received from the operating system.

12. The information handling system of claim 11, wherein the processor circuitry has a thread scheduling register, each thread has a corresponding thread identifier, and the operating system is operable to load a schedule of selected thread identifiers as respective entries in the thread scheduling register.

13. The information handling system of claim 12, wherein the processor circuitry is operable to:
i) read an index, wherein the index points to one of the entries of the thread scheduling register;
ii) read, for the entry indicated by the index read in i), the thread identifier stored therein;
iii) execute at least one instruction for the thread corresponding to the identifier read in ii);
iv) increment the index to point to a next entry in the thread scheduling register;
v) read, for the entry indicated by the index read in iv), the thread identifier stored therein; and
vi) execute at least one instruction for the thread corresponding to the identifier read in v).

14. The information handling system of claim 12, wherein the operating system is operable to communicate to the processor circuitry a selected length for the thread scheduling register.

15. The information handling system of claim 12, wherein at least one of the threads in the schedule comprises a dynamic scheduling thread, and the processor circuitry is operable to modify an entry in the thread scheduling register responsive to executing the dynamic scheduling thread, so that the thread schedule is modified dynamically.

16. The information handling system of claim 15, wherein the processor circuitry is operable to poll I/O devices responsive solely to the dynamic scheduling thread, rather than responsive to timer circuitry.

17. The information handling system of claim 11, wherein the processor circuitry is operable to switch from executing one of the threads with one of the contexts to executing another of the threads with another of the contexts in response to encountering a stall for a thread.

18. The information handling system of claim 11, wherein the processor circuitry is operable to switch to executing a special thread responsive to at least one of the following events:
a system call, an interrupt, and a trap condition.

19. The information handling system of claim 13, wherein for each fetching of the at least one instruction only a single instruction is fetched.

20. The information handling system of claim 13, wherein for each fetching of the at least one instruction numerous instructions are fetched.

21. A computer program product for scheduling multiple instruction threads for a processor in an information handling system, wherein the computer program product comprises instructions for communicating to processor circuitry a selected schedule of instruction threads for a set of instructions, and wherein the processor circuitry switches from executing one of the threads with one of the contexts to executing another of the threads with another of the contexts, responsive to the received schedule.

22. The computer program product of claim 21, wherein the computer program product comprises instructions for assigning each thread a thread identifier and for loading a schedule of selected thread identifiers as respective entries in a thread scheduling register.

23. The computer program product of claim 22, wherein responsive to receiving the schedule the processor circuitry:
i) reads an index, wherein the index points to one of the entries of the thread scheduling register;
ii) reads, for the entry indicated by the index read in i), the thread identifier stored therein;
iii) executes at least one instruction for the thread corresponding to the identifier read in ii);
iv) increments the index to point to a next entry in the thread scheduling register;
v) reads, for the entry indicated by the index read in iv), the thread identifier stored therein; and
vi) executes at least one instruction for the thread corresponding to the identifier read in v).

24. The computer program product of claim 22, comprising instructions for communicating to the processor circuitry a selected length for the thread scheduling register.

25. The computer program product of claim 22, comprising instructions for a dynamic scheduling thread, wherein the dynamic scheduling thread is included in the schedule communicated to the processor circuitry so that processor circuitry execution of the dynamic scheduling thread modifies an entry in the thread scheduling register.

26. The computer program product of claim 25, comprising instructions for polling I/O devices responsive solely to the dynamic scheduling thread rather than responsive to a timer.

27. The computer program product of claim 21, wherein the switching is further responsive to encountering a stall for a thread.

28. The computer program product of claim 21, wherein the processor circuitry switches to executing a special thread responsive to at least one of the following events: a system call, an interrupt, and a trap condition.

29. The computer program product of claim 23, wherein for each fetching of the at least one instruction only a single instruction is fetched.

30. The computer program product of claim 23, wherein for each fetching of the at least one instruction numerous instructions are fetched.
